(19) United States
(12) Patent Application Publication
(10) Pub. No.: US 2010/0326256 A1
(43) Pub. Date: Dec. 30, 2010

(54) Methods for Online Collaborative Music Composition

(76) Inventor: Parker M.D. Emmerson, Chapel Hill, NC (US)

Correspondence Address: TRIANGLE PATENTS, P.L.L.C., P.O. BOX 28539, RALEIGH, NC, 27611-8539, US

(21) Appl. No.: 12/494,945

(22) Filed: Jun. 30, 2009

(51) Int. Cl. G10H 1/36

(52) U.S. Cl. 84/610

(57) ABSTRACT

Systems and methods for creating and editing collaborative music compositions via a computer network, including remote uploading tracks by musicians, and for creating and joining a band, wherein the system and methods provide for at least one musician to join a virtual group of at least one other musician for the purpose of virtual collaborative creating and/or editing music tracks remotely, via an online network and interactive website therefor.

### BACKGROUND OF THE INVENTION

1. Field of the Invention

The present invention relates generally to online music collaboration. Further, the present invention relates to methods for providing collaborative music compositions via a computer network.

2. Description of the Prior Art

It is known in the relevant art to provide for online music uploading and downloading. However, typically this is done for completed musical compositions. Some web-based options provide for musicians to collaborate on projects, but do not provide for collaborative groups or virtual bands. These sites provide for only one single track to be uploaded, not multiple tracks at the same or similar time from the same collaborative group. By way of example, this might be a guest artist performing with an existing band on one track. Thus, there remains a need for online, collaborative group music compositions for multiple tracks. Also there remains a need for selective grouping and multiple group collaborations on an ongoing basis with these methods.

### SUMMARY OF THE INVENTION

A first aspect of the present invention is to provide methods for creating and editing collaborative music compositions via a computer network, including remote uploading tracks by musicians. Another aspect of the present invention provides methods for creating and joining a band, at least one musician to join a virtual group of at least one other musician for the purpose of virtual collaborative creating and/or editing music tracks remotely, via an online network and interactive website therefor.

These and other aspects of the present invention will become apparent to those skilled in the art after a reading of the following description of the preferred embodiment when considered with the drawings, as they support the claimed invention.

### BRIEF DESCRIPTION OF THE DRAWINGS

The attached FIGS. 1-11 illustrate screen shots of graphic user interface (GUIs) views of web-based interfaces as described hereinbelow.

FIGS. 12-30 illustrate screen shots of GUIs showing aspects of the interactive website for systems and methods of the present invention.

FIGS. 31-40 illustrate screen shots of GUIs showing aspects of the interactive website for systems and methods of the present invention, with substantive illustration of virtual band and musician aspects in particular.

### DETAILED DESCRIPTION

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

The present invention provides a method for creating and editing collaborative music compositions via a computer network, including remote uploading tracks by musicians. Additionally, the present invention provides methods for creating and joining a band, at least one musician to join a virtual group of at least one other musician for the purpose of virtual collaborative creating and/or editing music tracks remotely, via an online network and interactive website therefor.

The present invention provides for automated systems for providing online music composition including: an interactive website accessible from a remote computer device via a network, the website being operable for receiving a first track uploaded through the network from a first remote source, the first track created by at least one musician entity; the website further operable for automatically saving and categorizing the at least one track according to the musician entity and a music genre; the website further operable for receiving a second track from a second remote source, the second track created by a second musician entity, selectively combining the first track and the second track, and saving the combined tracks for creating a collaborative music composition. Preferably, the system is accessible remotely via a multiplicity of musician entities for uploading, editing, and creating collaborative music compositions selectively with other musician entities; remote access is based upon user accounts for the musician entities and their corresponding virtual bands, when they exist.

The website is operable to provide for any of the musician entities to access and edit the collaborative music composition via network connection to the interactive website.

Furthermore, the present invention provides for methods for providing online music composition including the steps of: providing an interactive website accessible with a remote computer via a network, wherein the website is operable for receiving a first track from a first remote source, the first track being created by at least one musician entity, saving and categorizing the at least one track according to musician and genre, receiving a second track from a second remote source, the second track created by a second musician entity, selectively combining the first track and the second track, and saving the combined tracks for creating a collaborative music composition.

Also the present invention provides for methods for online music collaboration including the steps of: providing an interactive website accessible with at least one remote computer device via a network, wherein the website is operable for receiving a first track from a first remote source, the first track being created by at least one musician entity, saving and categorizing the at least one track according to musician and genre, receiving a second track from a second remote source, the second track created by a second musician entity, selectively combining the first track and the second track, and saving the combined tracks for creating a collaborative music composition; and wherein the musician entities are self-selectively combinable to form at least one virtual band for online music creation, editing, and social network-based distribution through the interactive website.

The methods further include the steps of editing the combined tracks, and the interactive website is operable for receiving a multiplicity of tracks from more than one remote musician entity. Advantageously, the interactive website system and methods of the present invention are operable for automatically categorizing the virtual bands based upon a track categorization of composite tracks and/or based upon a musician categorization of any or all of the at least one musician entities that contribute at least one track to the composite track.

Referring now to the drawings in general, the illustrations are for the purpose of describing a preferred embodiment of the invention and are not intended to limit the invention thereto. For the purpose of this application, a “track” is defined as and refers to a music track. Typically, according to the present invention, music tracks are composed and produced by at least one musician, often a single musician, who is one of the users of the web-based methods of providing online collaborative music compositions, wherein the musician uploads his/her track to the site via an interactive website accessible through a graphic user interface viewable on a display, the display constructed and configured for interactive user inputs and audiovisual outputs through a computer device, such as a computer having access to the website via a network, such as the Internet, categorizing the track within at least one genre selection on the interactive website.

Regarding methods for the present invention, a web-based graphic user interface (GUI) is provided with interactive functionality so that a user can enter information personally related to himself/herself. First, a user provides a login using a user identification (user ID) and password, to create a user profile and/or account. The user profile may include a musician profile and/or a listener profile. After registration, in one embodiment of the present invention, the user can view music available for review and/or download from the website, and create user-specific playlists. Each track of music available on the website may be selectively included on a given user profile, so that a user may build his/her own playlist(s). The user can visit a band's webpage within the site, review a song and then click-select to add it to his/her playlist. Also, he/she can choose which playlist to add to, in the case of multiple playlists. However, optionally, a user can selectively add another user's entire playlist and/or a band or musician's playlist based upon music that is available for download. In this manner, listener users become distributors for the music. Downloading is preferably based on a pay-per-download basis, with proceeds being distributed to the contributors, including individual musicians from virtual bands. Alternatively, another fee may be paid for downloading another user's playlist in its entirety.

In the methods of the present invention, musician users on the site start a band. That initial band member user can then go directly to other musicians' pages on the site and invite them to join that band. Alternatively or additionally, musicians can go to band pages on the site and audition to join by uploading a track for the band to review. The band receives an automatic notification of the audition track upload and reviews it. The band can then accept or reject the auditioning musician and send a notification of that selection. If accepted, then the new musician can upload tracks that are optionally integrated with existing tracks of the band. At any time an existing band member can upload a track for review by the band and/or for integration to provide a new song based on the integration. The created track that is uploaded can be provided or layered on top of an existing song or other tracks by the band members. Preferably, a musician must initiate a new band and then grow the band as set forth hereinabove. However, notably, musicians can be members of multiple bands or groups for ongoing collaborative music creation through the site. The band members can then invite other musicians to join the band through the site, request auditions from other musicians on the site, and/or receive unsolicited auditions through the site. Importantly, the musicians do not need to ever be in proximity or create the final song contemporaneously; rather, the collective contributions through the site over time create the final songs that are sold through the site to listener members. Also, there can be multiple tracks within one song, and multiple versions of a song, wherein each version has a different combination of tracks provided collaboratively through the site from the same or different musicians.

The present invention is illustrated by the interactive website for www.myblogband.com, which includes an Internet application with a specific functionality for providing virtual collaboration for musicians for creating and editing composite music tracks from a multiplicity of remote musician entities. This interactive website application is operable to provide users with the ability to create and/or join a band remotely from the other musicians in the band, by accessing the site for collaboration via a network, such as the Internet in a virtual workspace for multiple users. The systems and methods of the present invention, including the application, provide for the interactive website for remote users to start a band, invite others to join a band, maintain privacy on tracks by allowing or disallowing download of the song, create files called songs, upload multiple working versions of a song into that file, and select which track is displayed in the player on their band page on the interactive website. The website application also provides for each user or musician (or musician entity) in the band to invite other members to join the band (and thereby have access to all the tracks and uploads of other members of the band). According to one embodiment of the present invention, anyone on the site can also audition to be in a band (including uploading a track to a work in progress of a band of which they are not already a member). Any musician who is a member of the interactive website, for example as illustrated on Myblogband.com, can upload a track to a song file created by a band. Their file is stored with their name on it as the person who uploaded it and displayed on the tracks page, but the band does not necessarily have to use it. Throughout myblogband.com, the spaces allows html code posting.

On a band's page within the site, where multiple versions or tracks of a song exist, the band can select a default track to be listed on the webpage. Any track can be designated private or public by the band or a musician, thereby making it automatically non-downloadable or downloadable, respectively.

Referring now to the drawings specifically, FIG. 1 provides a GUI for a home page for a website operating according to one embodiment of the present invention. It provides several interactive options for users who visit the site, including profile creation, editing, and review options, which are illustrated here on the left side column. It also provides for any registered musician to start a band; band listings that provide for links to band web pages within the site are provided thereinbelow. Featured bands are listed at the central portion of the screen shot, and featured musicians on the right side.

FIG. 2 provides a GUI for an individual user's playlist, entitled “My Music.” Options for playing, editing, and deleting the tracks are provided for musician users. Dates of entry or upload are also provided. FIG. 3A provides an individual musician profile page, including photo, background, and other personal information, as well as tracks created by that user and uploaded to the site, including date/time stamp, and bands to which the musician is a contributing musician member or band member through the site. FIG. 3B provides a continuation of the individual musician profile page, further including comments from other users who are registered with the site. Public service ads by Google are also shown on the left side of the screen shot. FIGS. 3C-E provide more comments for the same musician page.

FIGS. 4, 5, and 6 provide band profile pages for different bands. The tracks are individually listed for each in the center of the page, including dates of creation/upload in the final form listed and total number of plays for each track. A download option is provided as well for each track.

FIGS. 7-10 provide screen shot displays for individual tracks by bands. Importantly, it is shown how on different dates/times there are different versions of the same track, including different band compositions, i.e., different musicians included on that track. In FIG. 8, three tracks are shown to illustrate how multiple versions of the same track are uploaded by different musicians in the same band on different dates and times; in this case, the band is called “secondary colors.” In FIG. 10, for example, two tracks are shown, in which one provides for a track with violin on top of the basic or base track by the band called “The Clinic.”

FIG. 11 provides an illustration of an interactive web page wherein the user establishes music search criteria by selecting the instrument type(s), genre(s), and indicates how many years the musician needs to have been playing. Also, a listing of the state or other geographic designation is provided (optional).

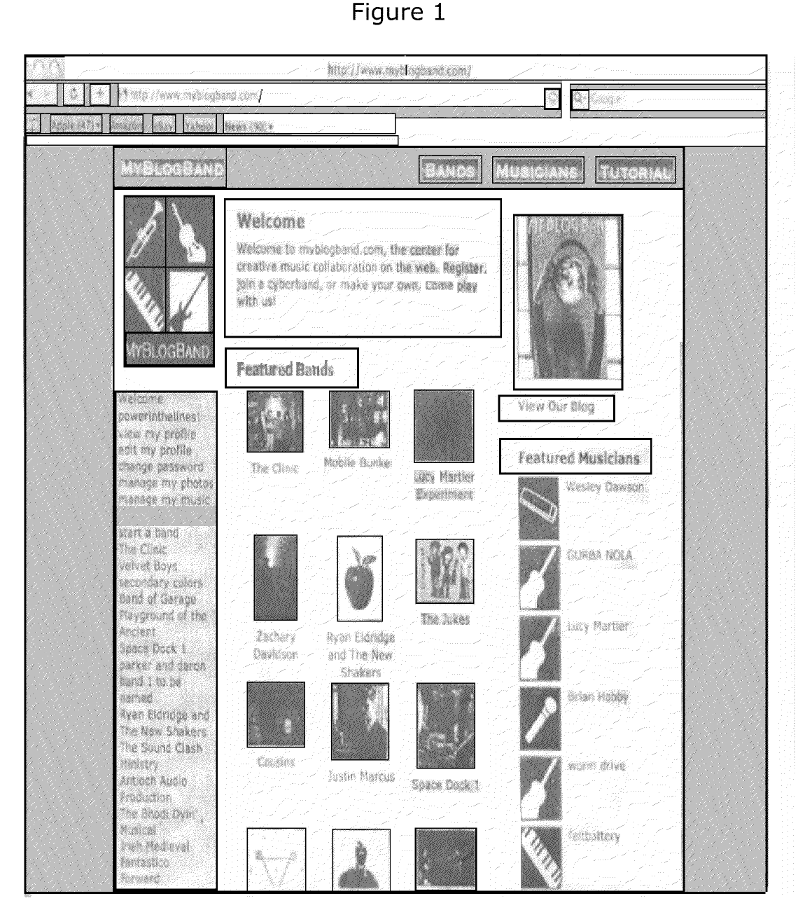

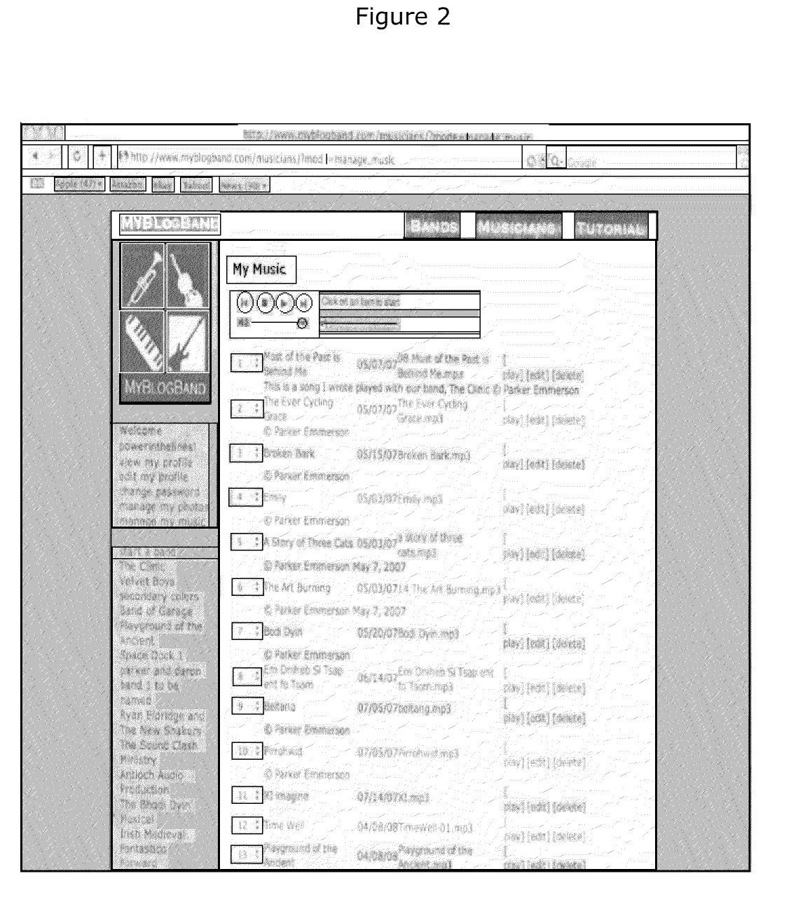

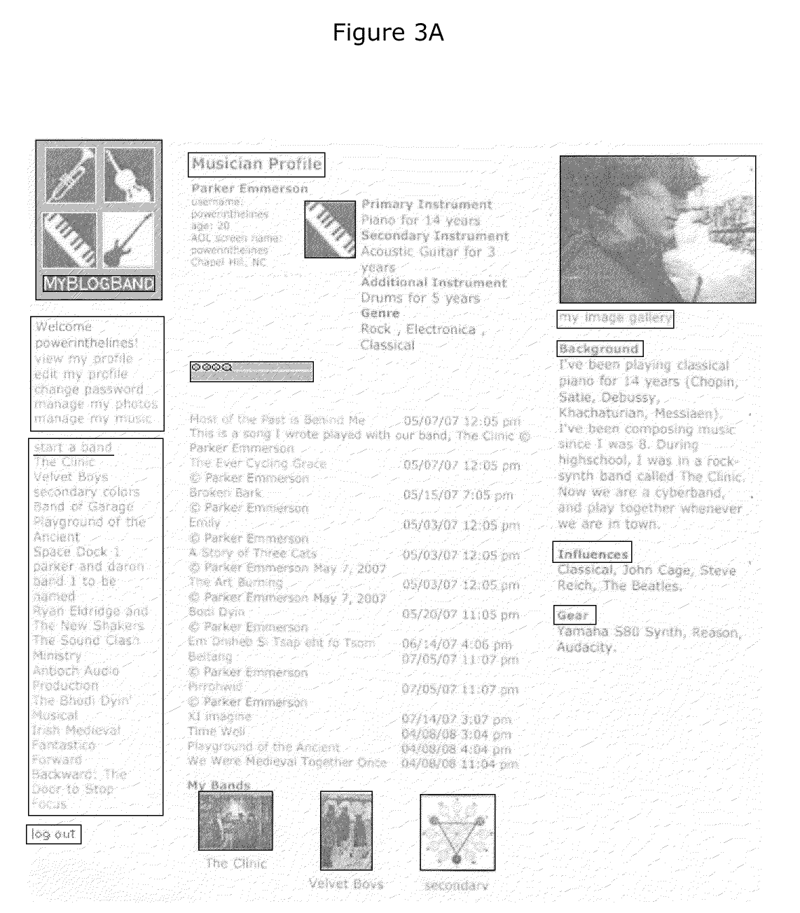

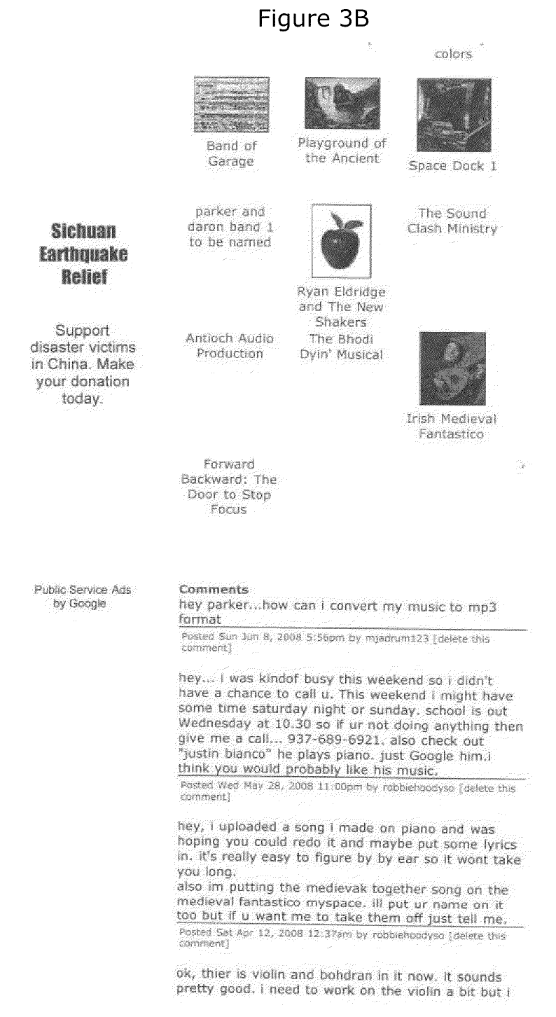

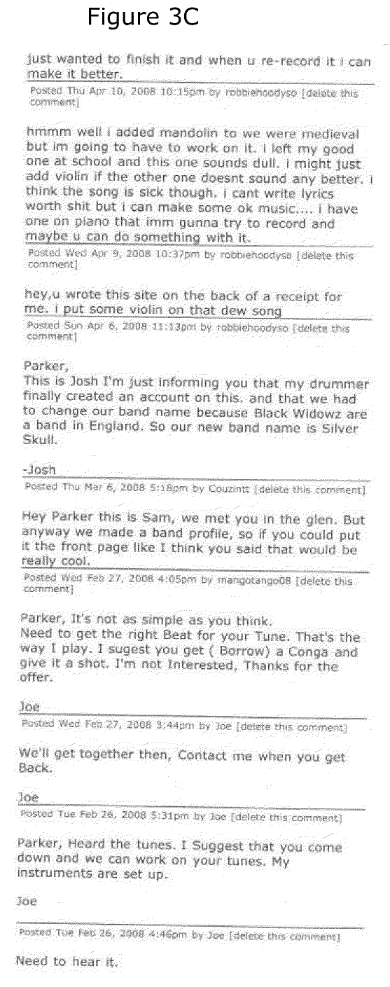

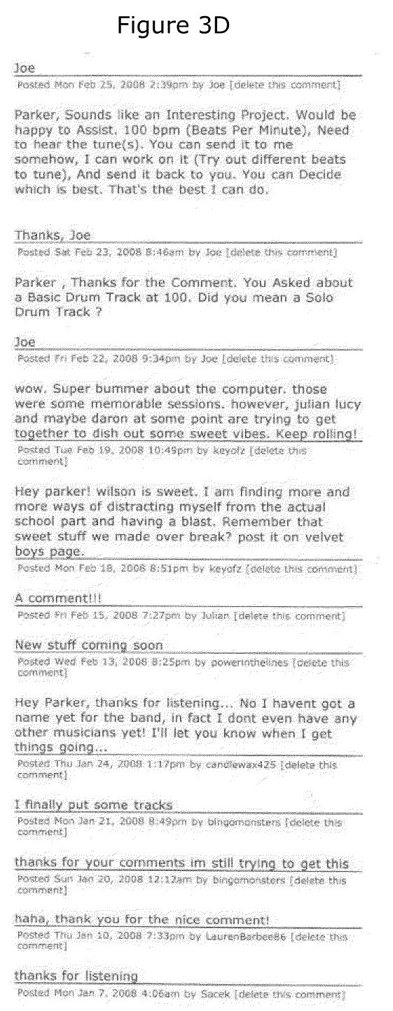

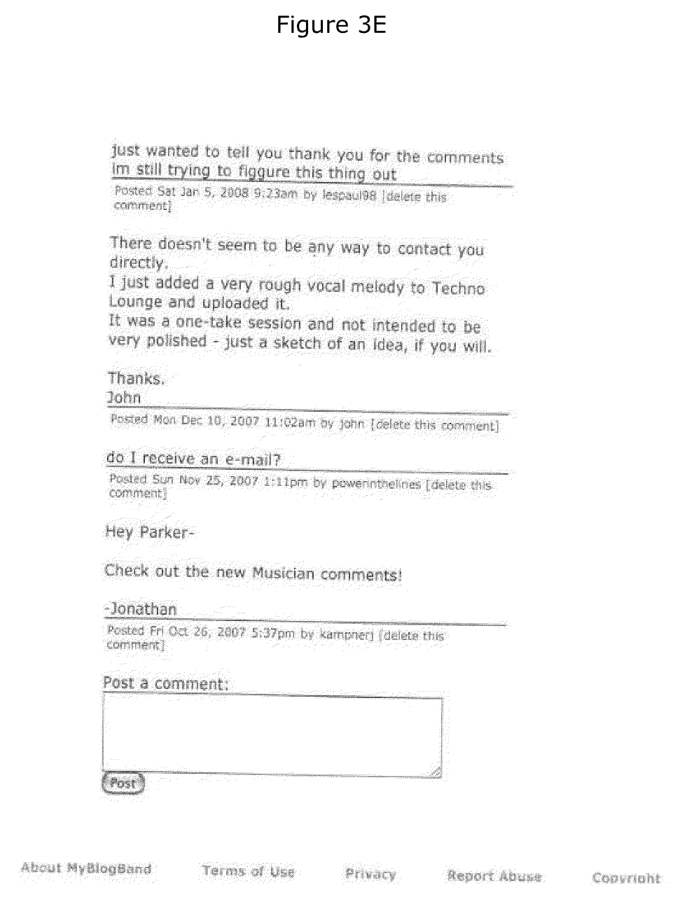

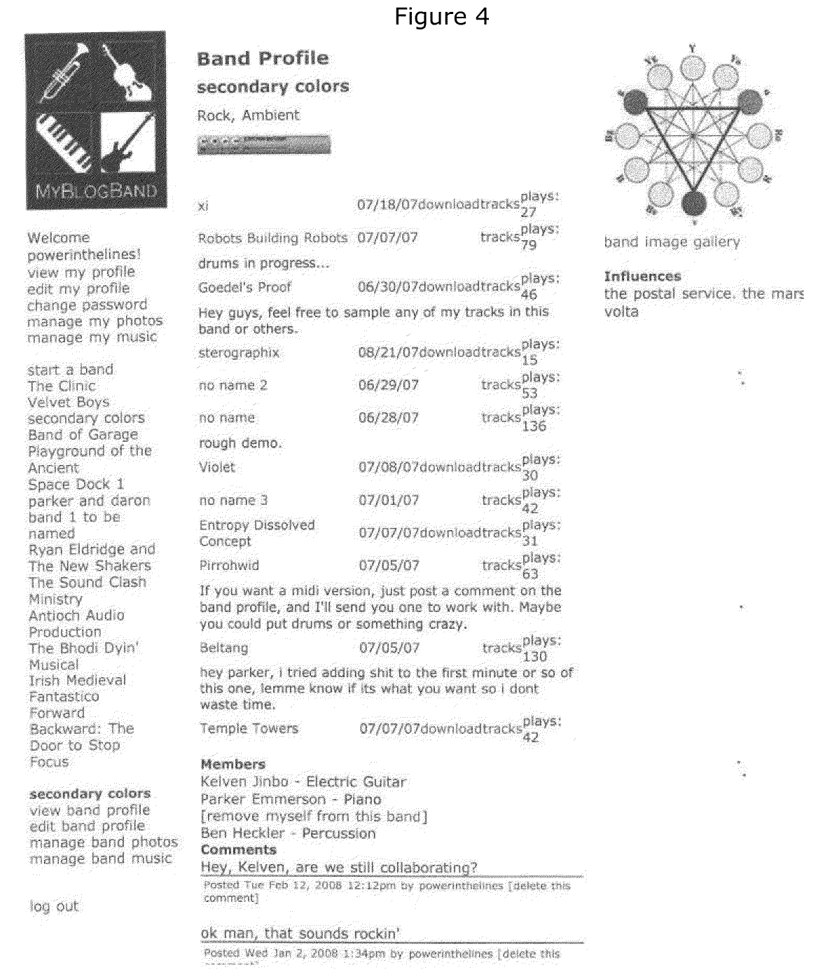

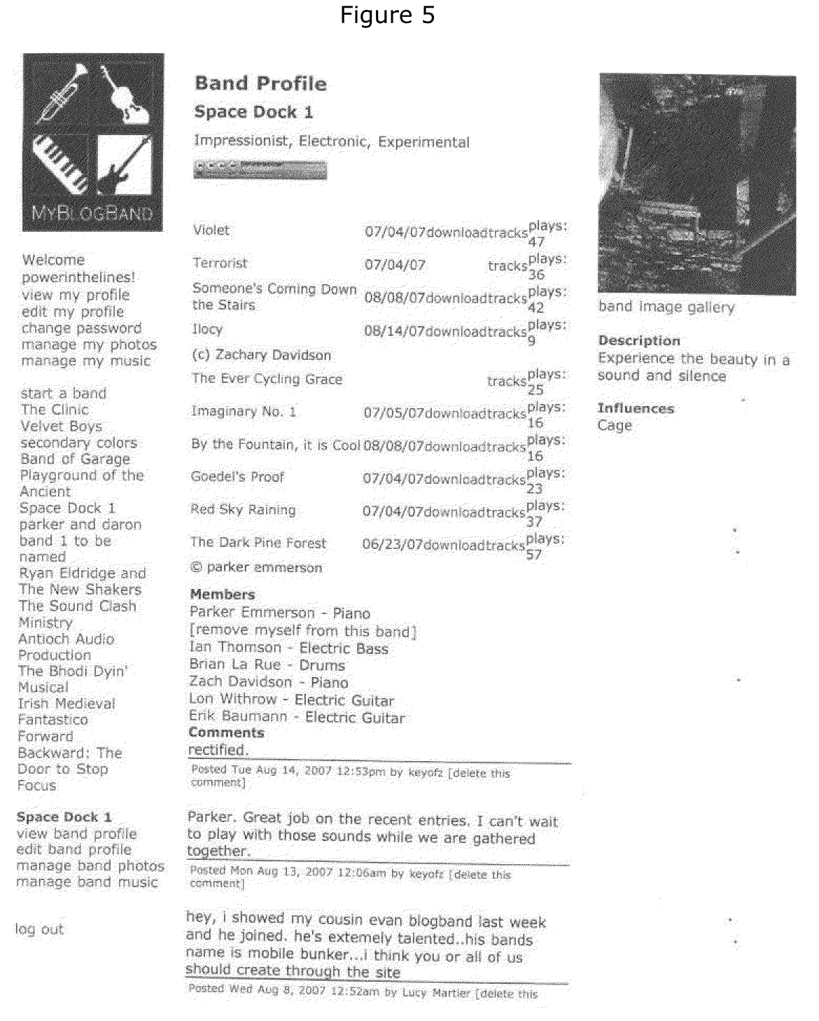

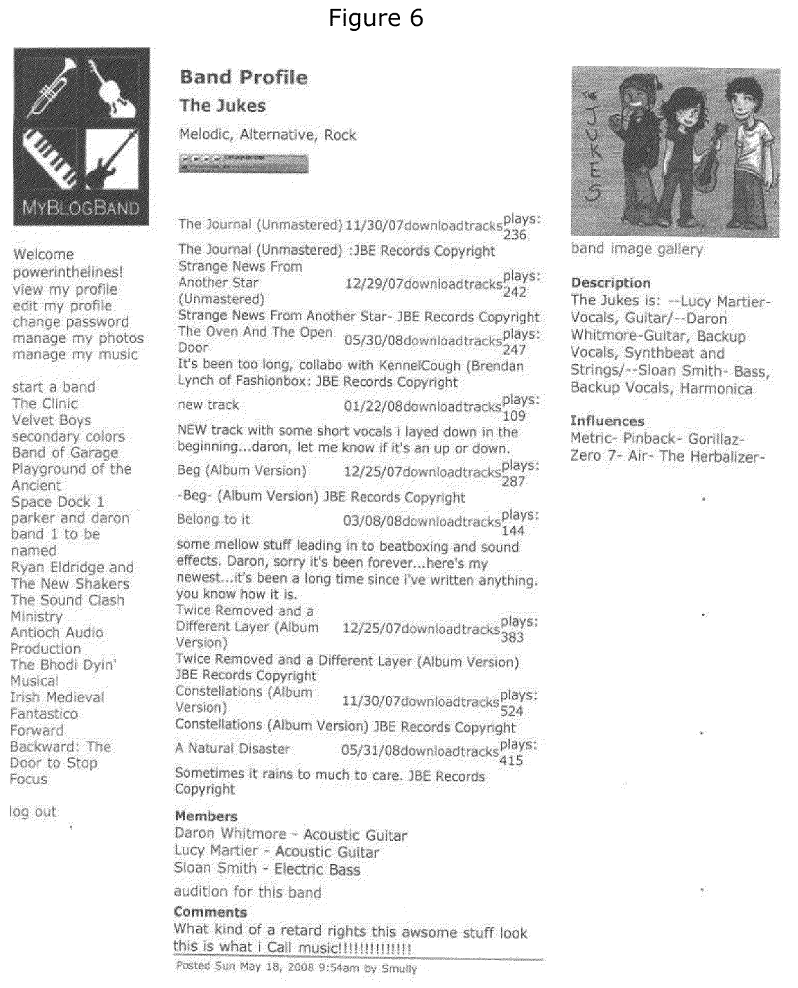

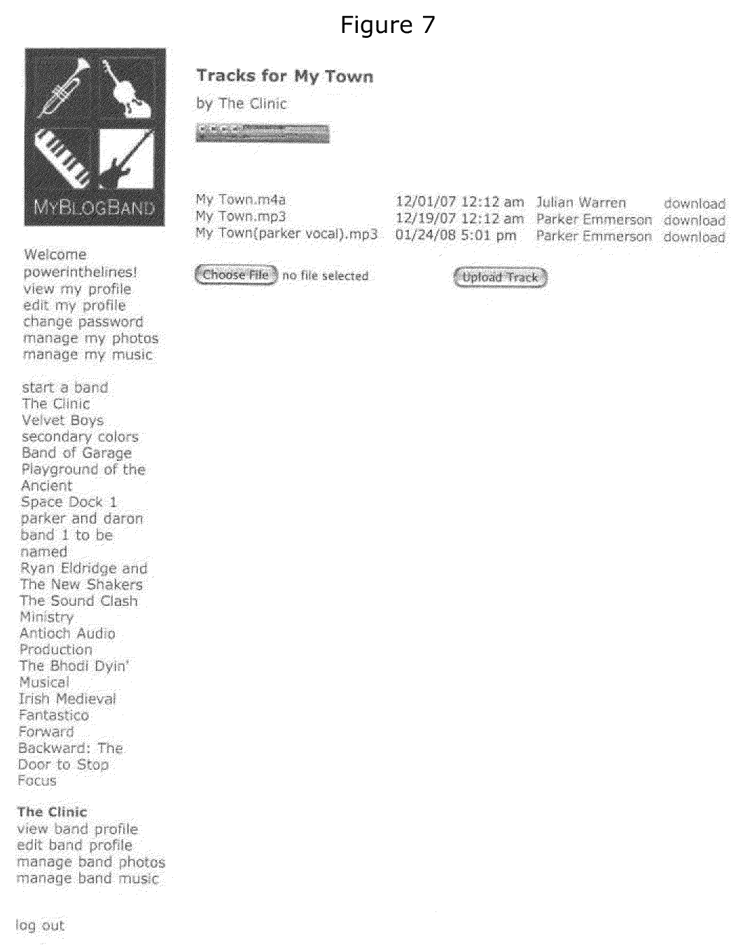

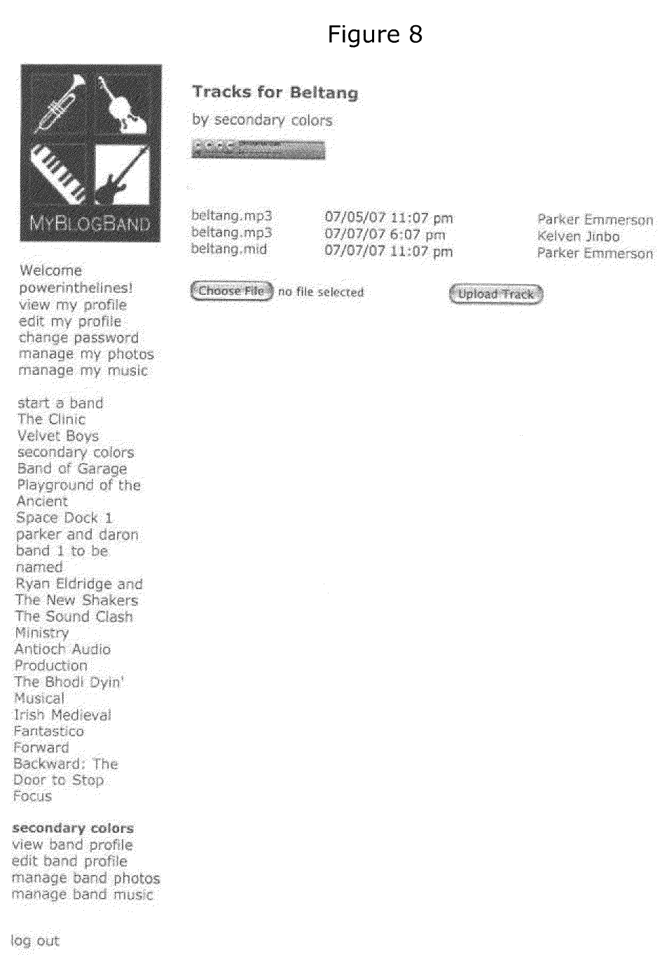

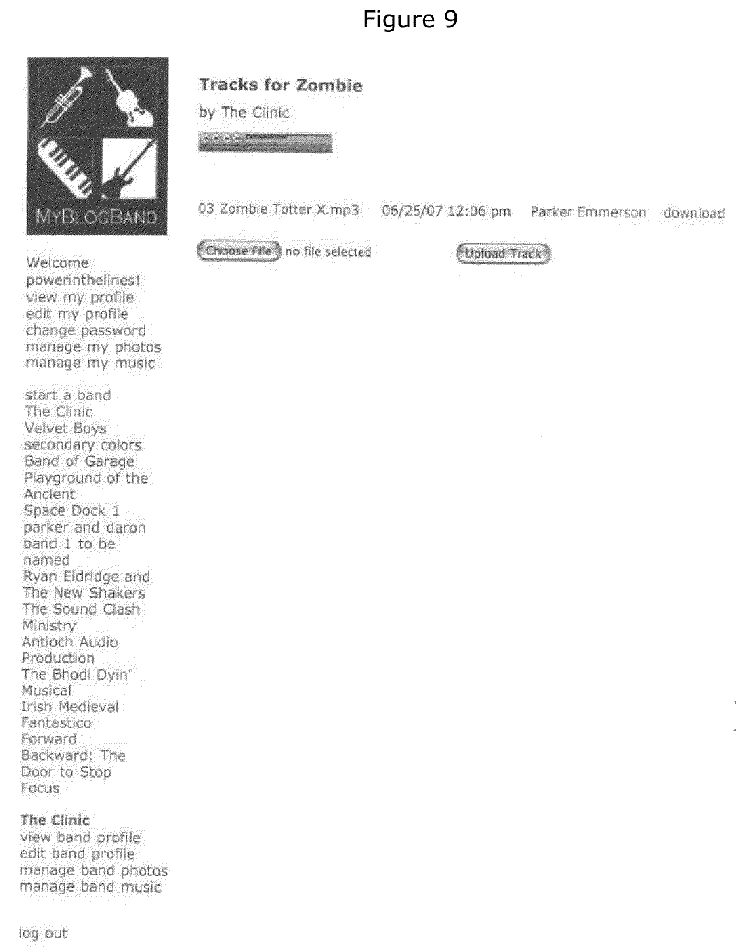

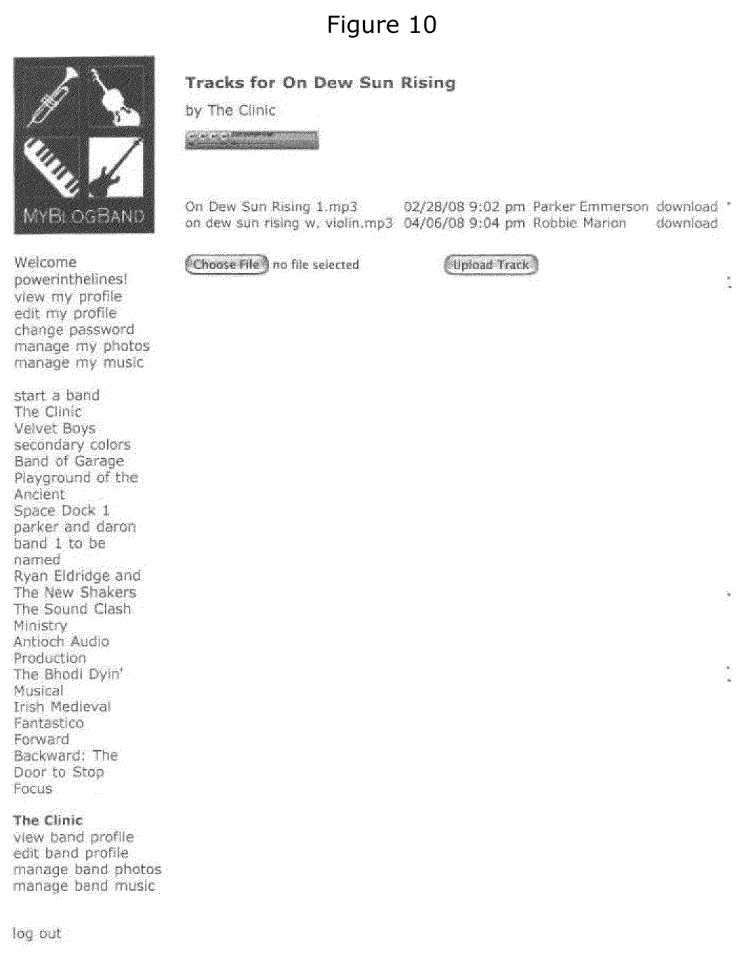

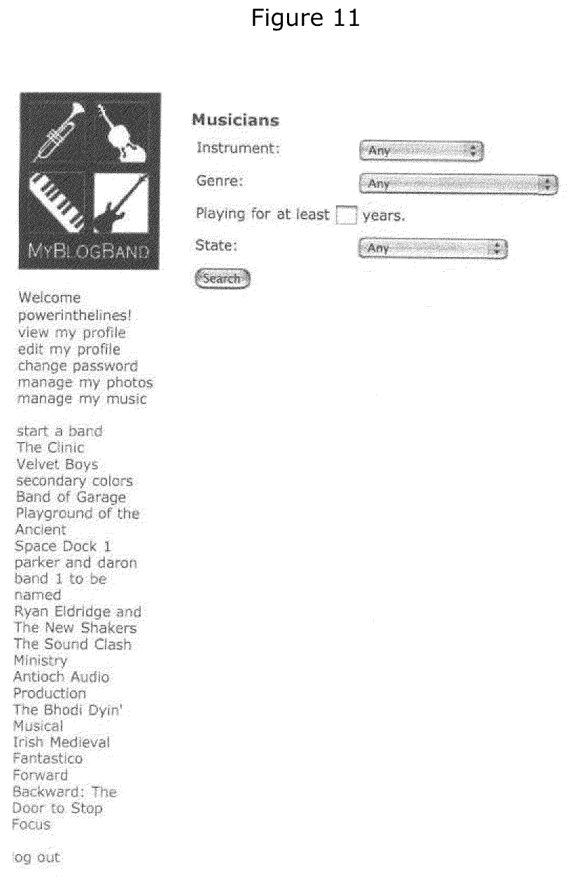

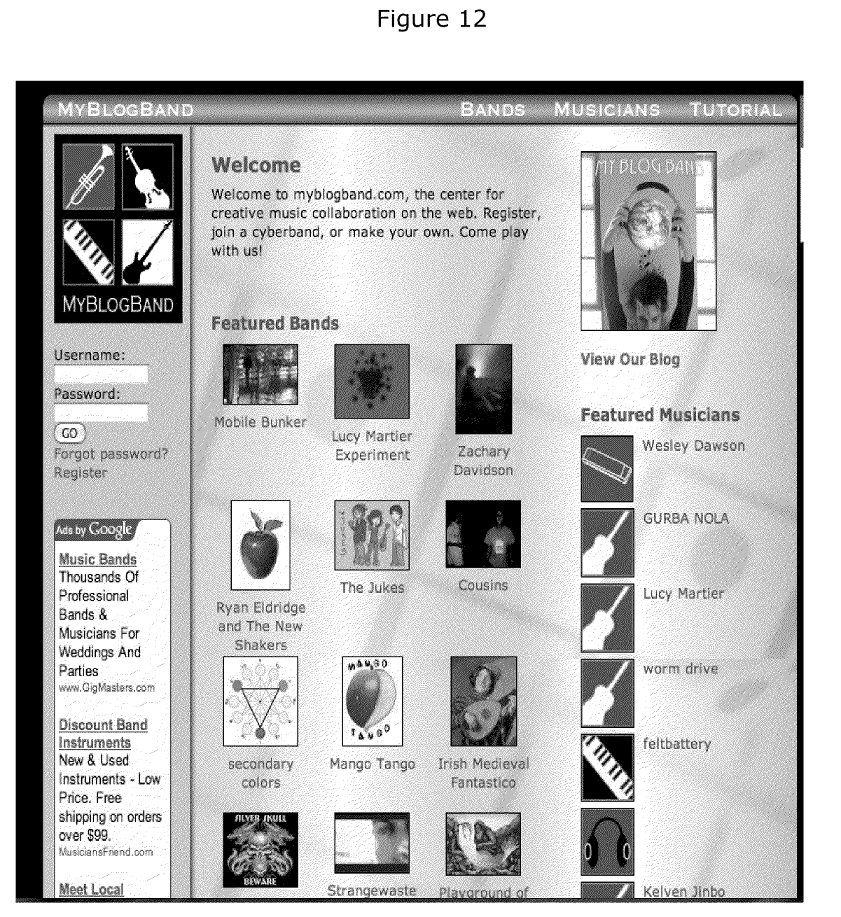

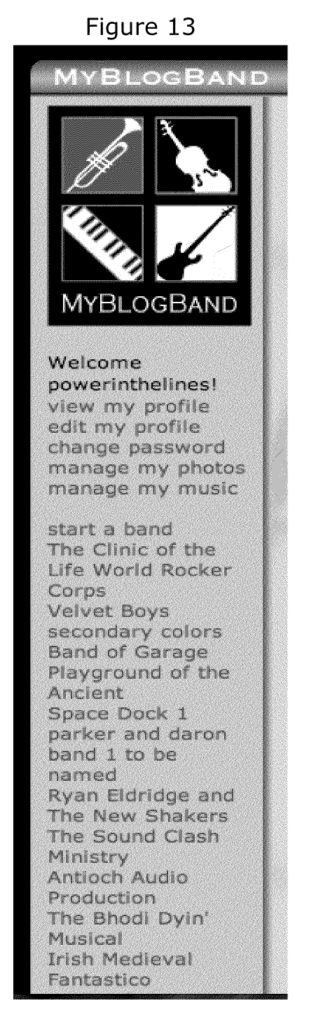

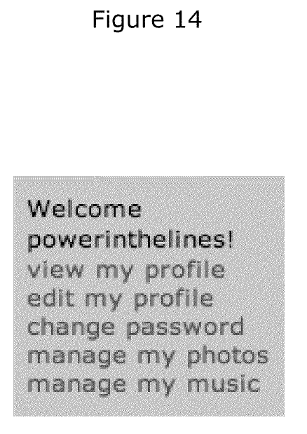

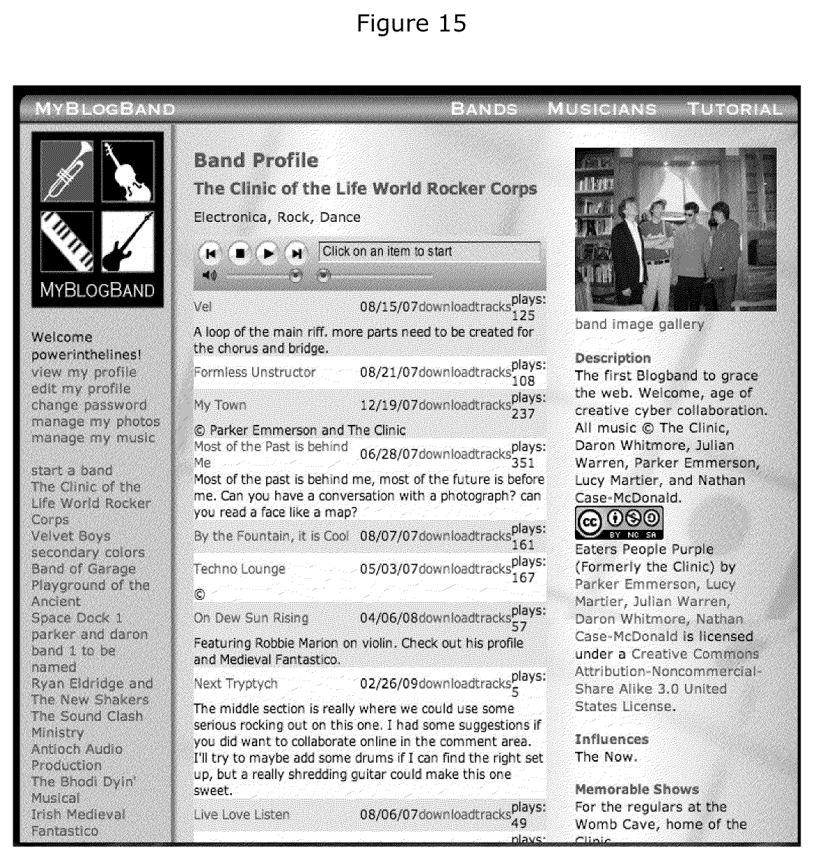

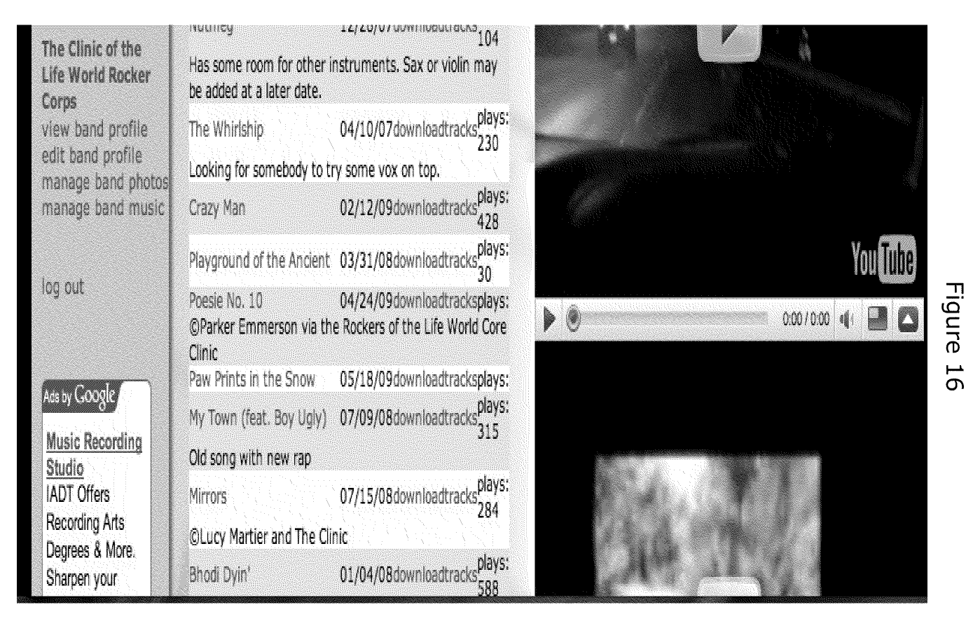

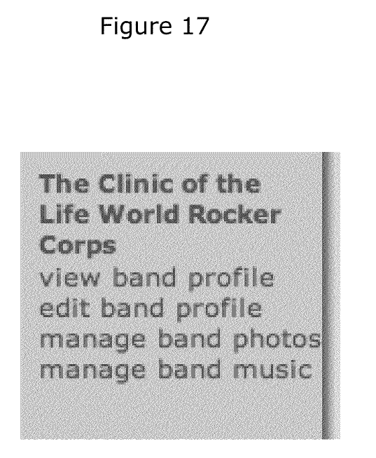

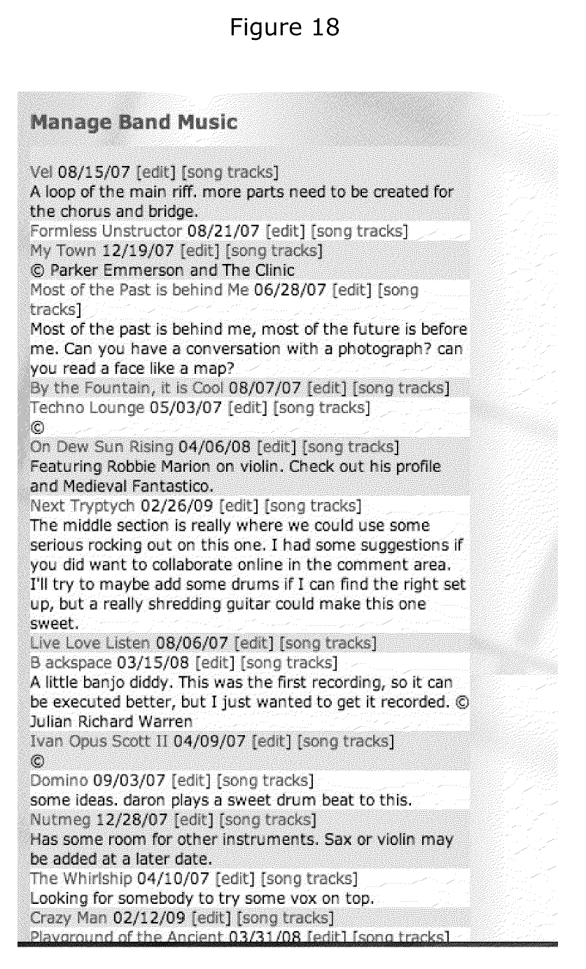

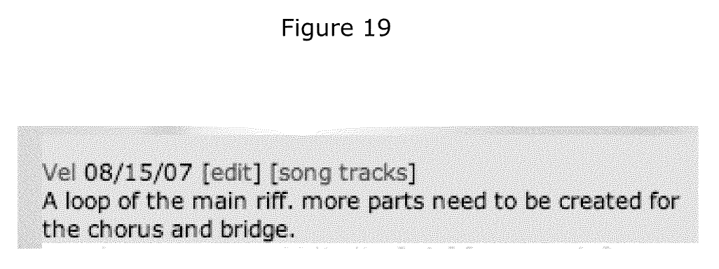

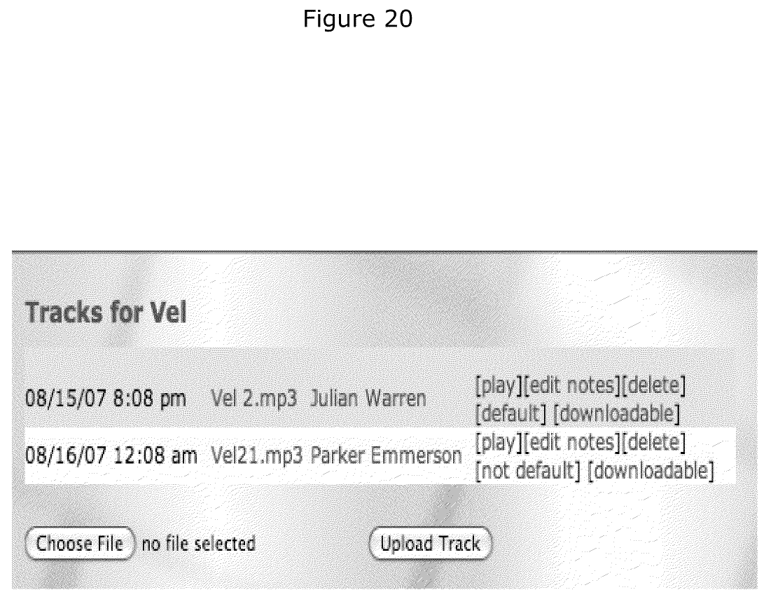

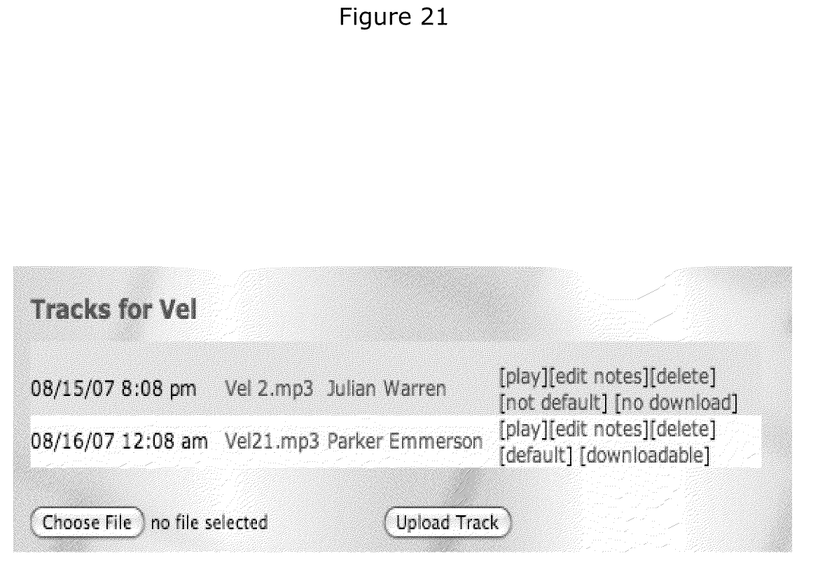

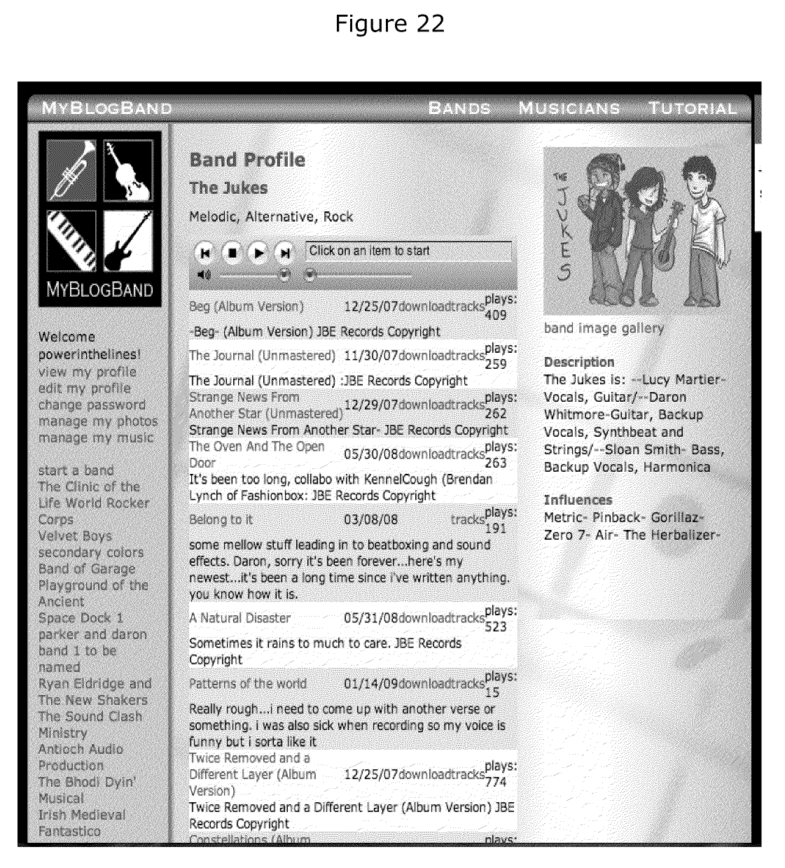

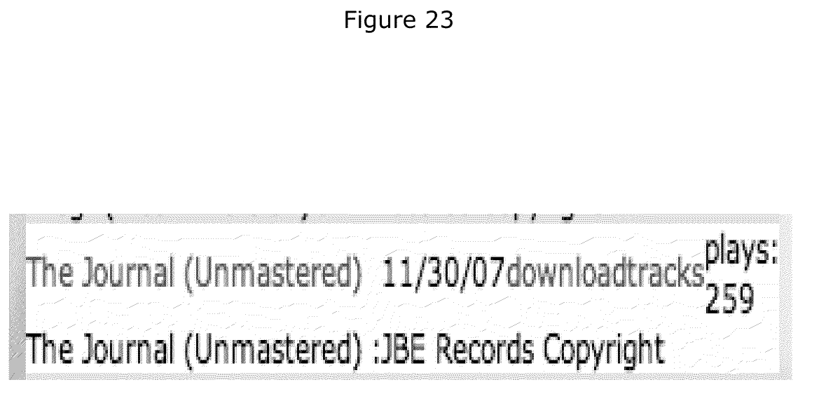

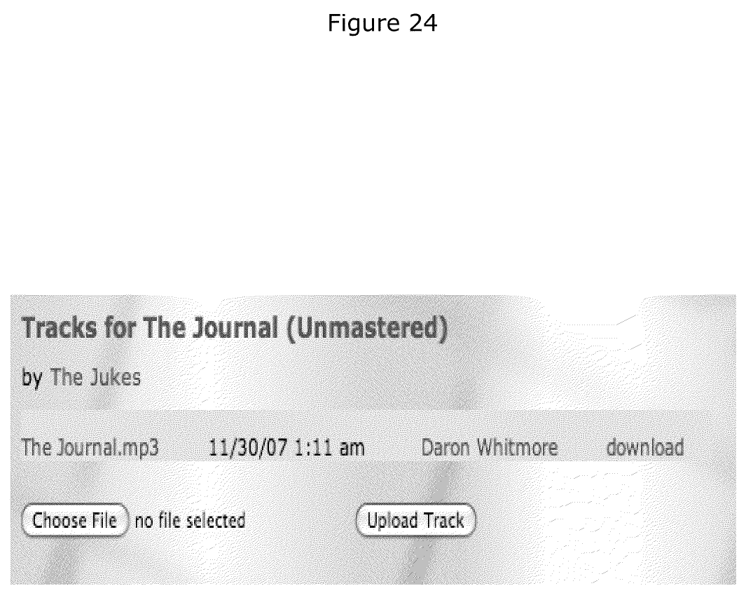

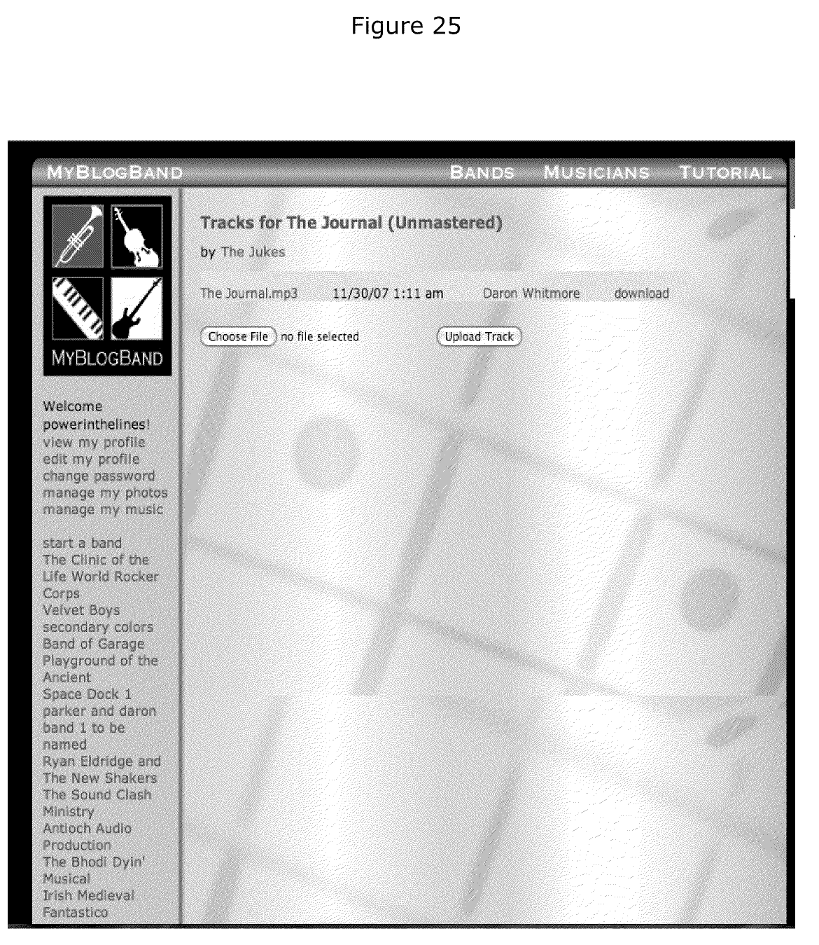

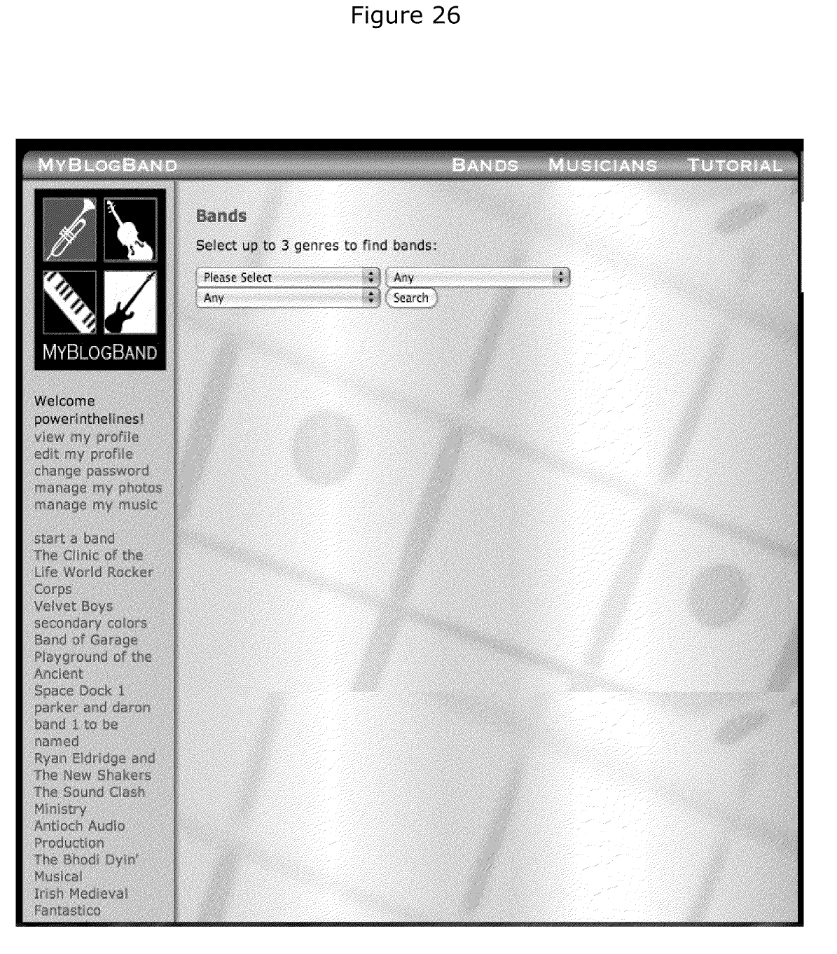

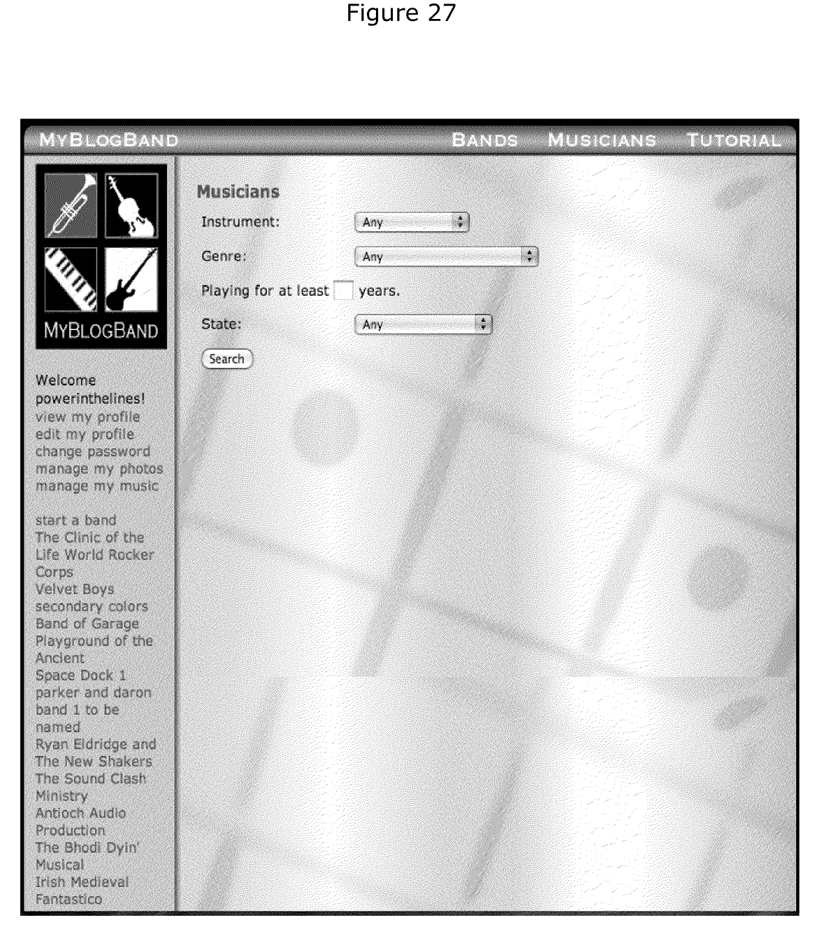

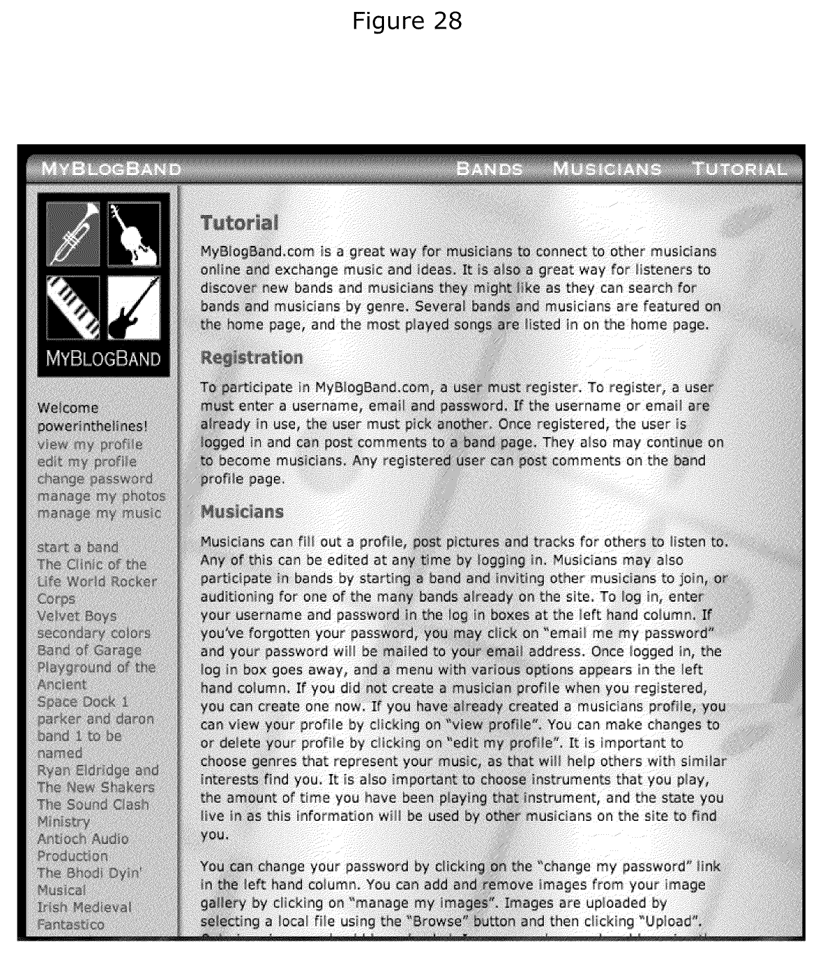

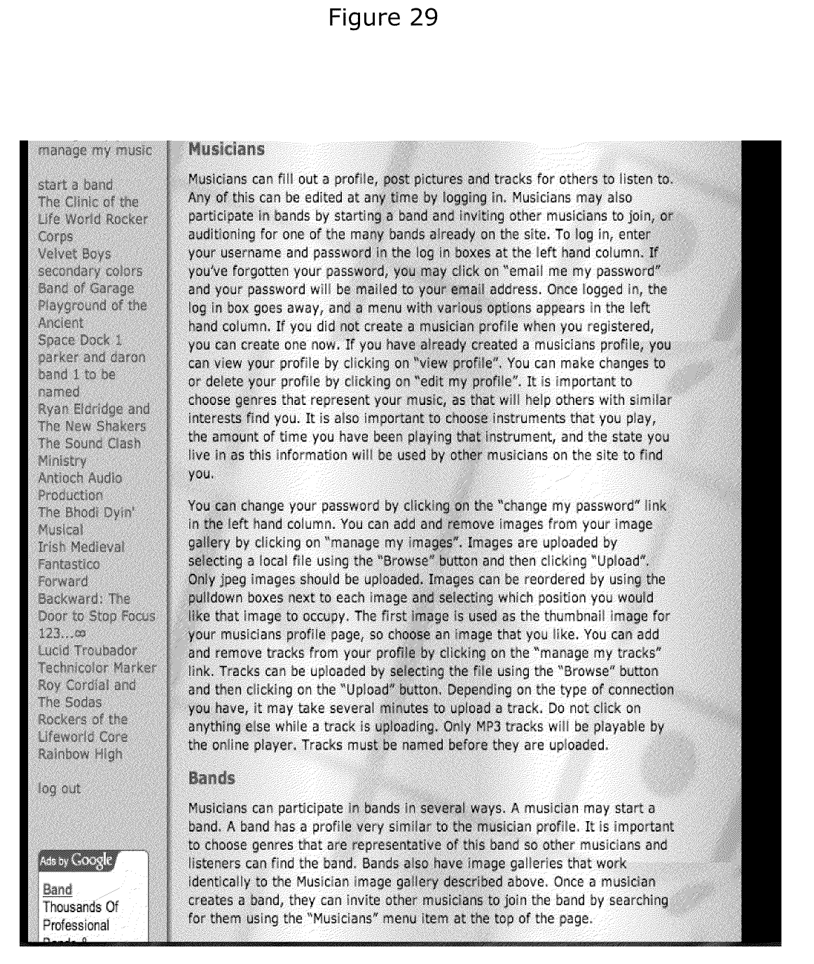

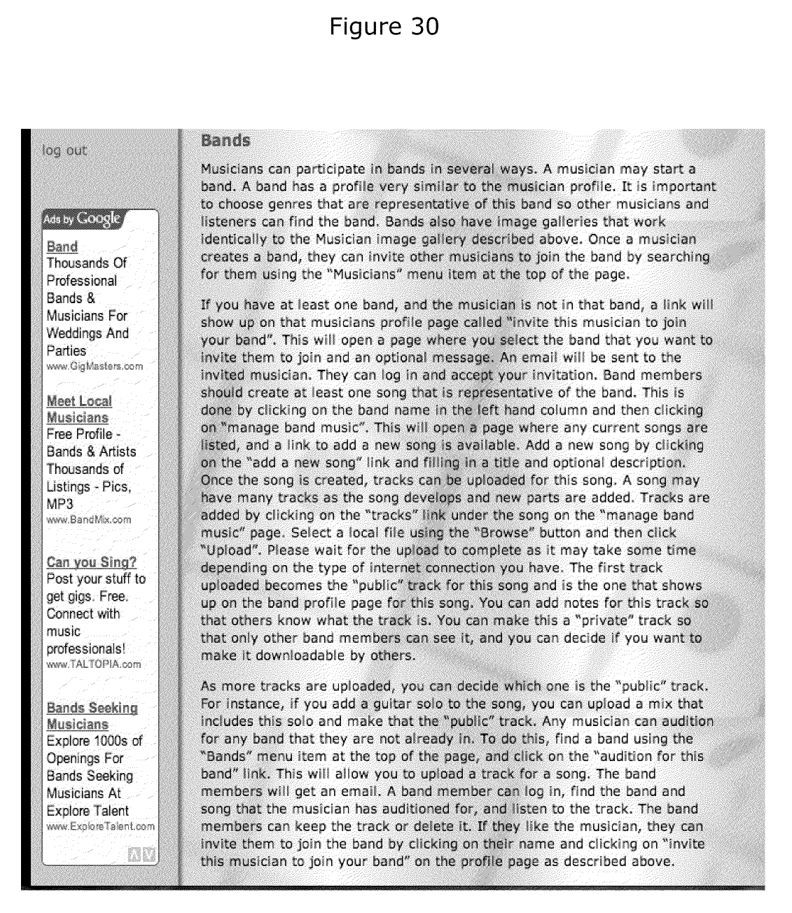

FIGS. 12-30 illustrate screen shots of GUIs showing aspects of the interactive website for systems and methods of the present invention.

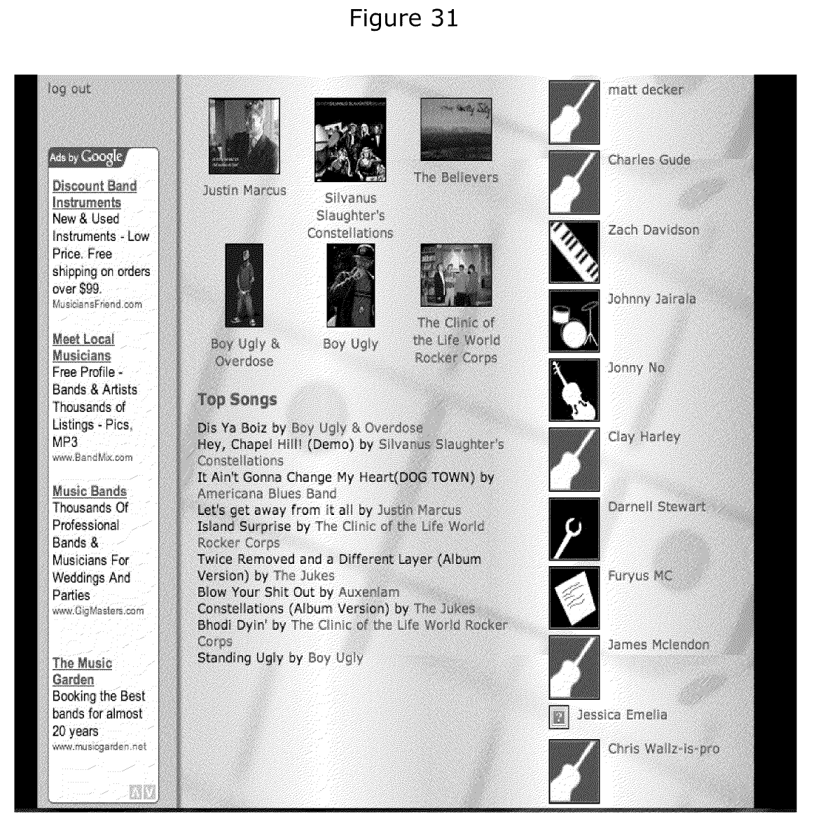

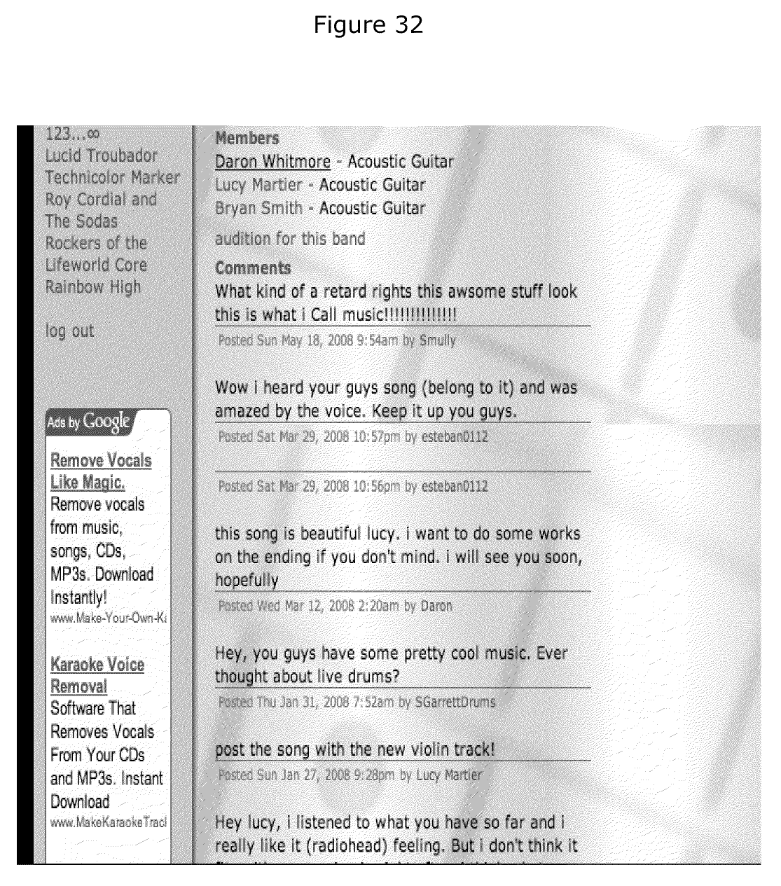

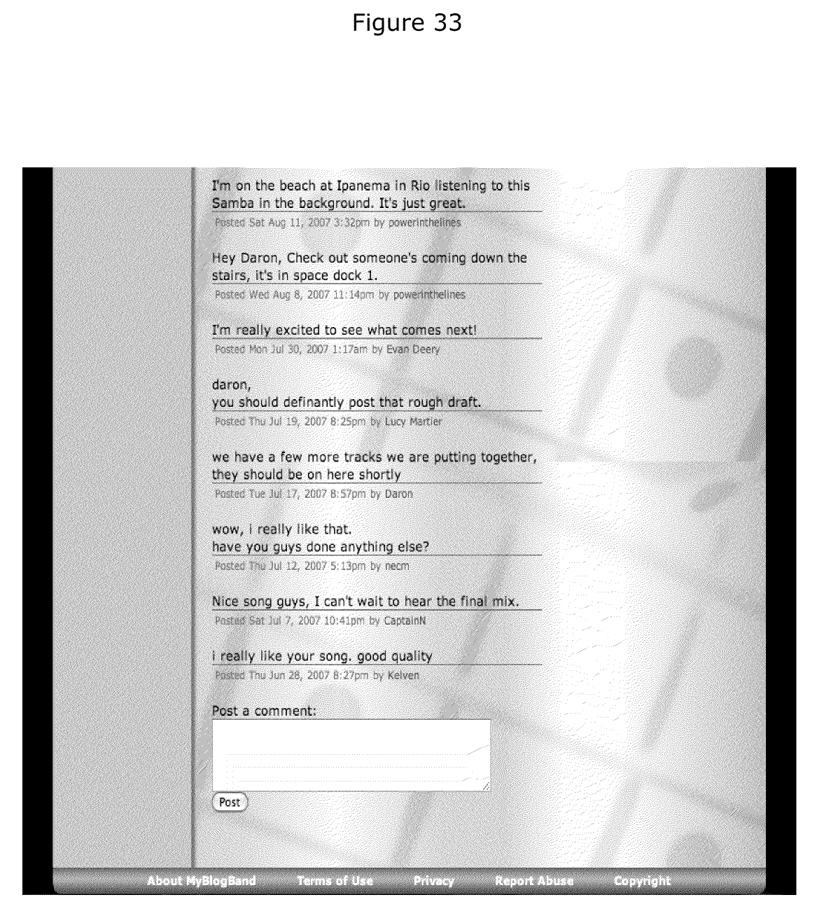

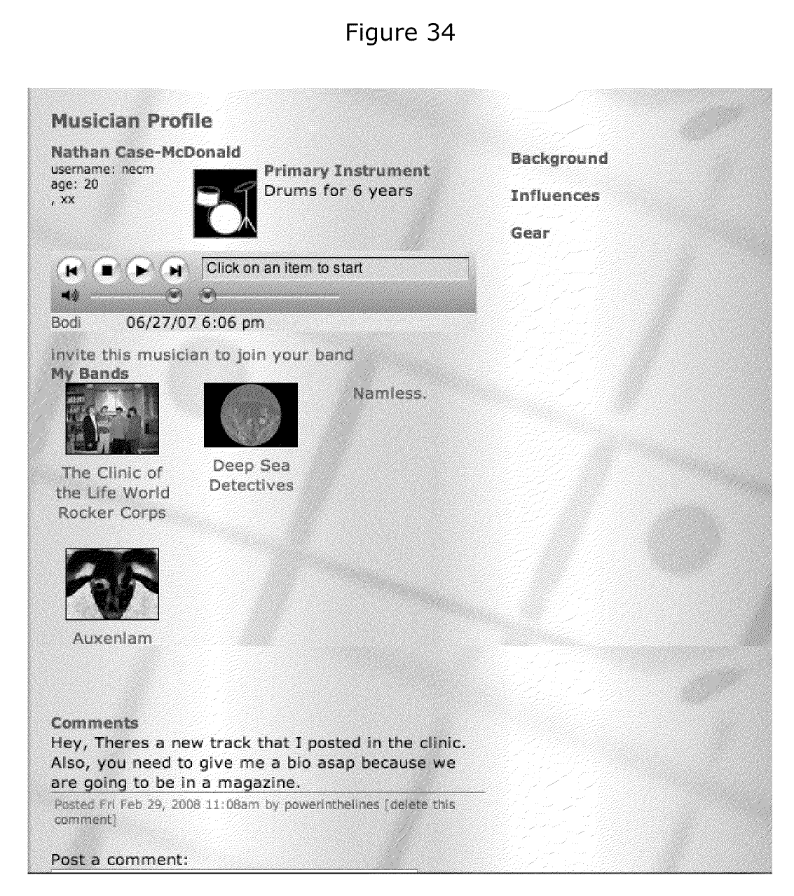

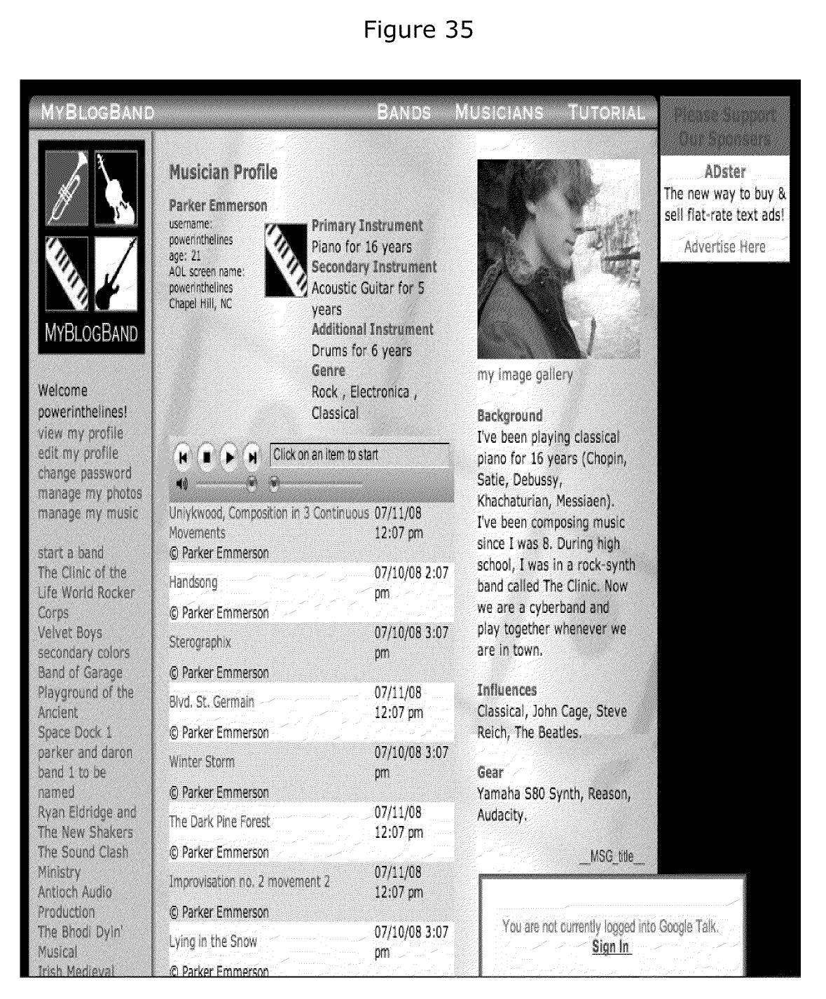

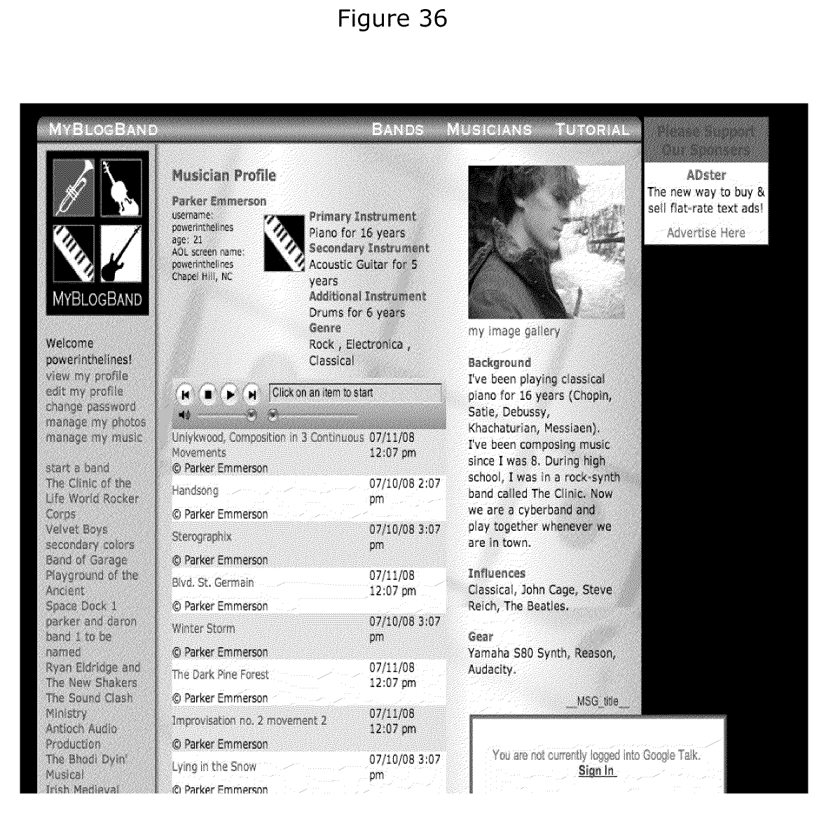

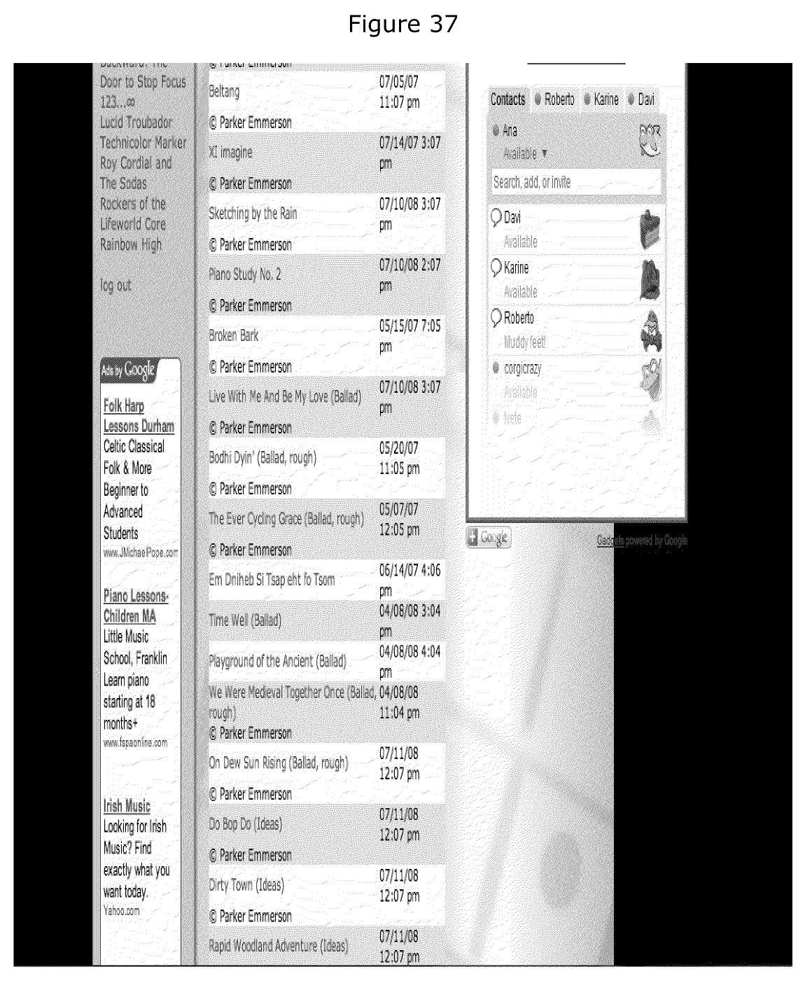

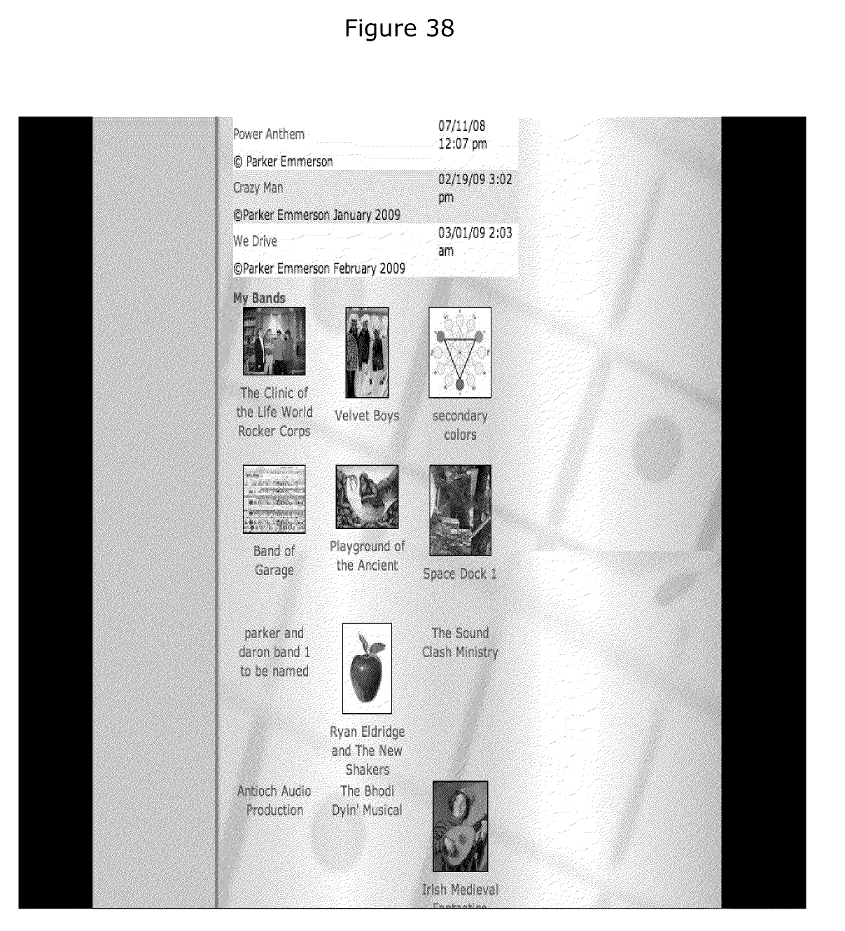

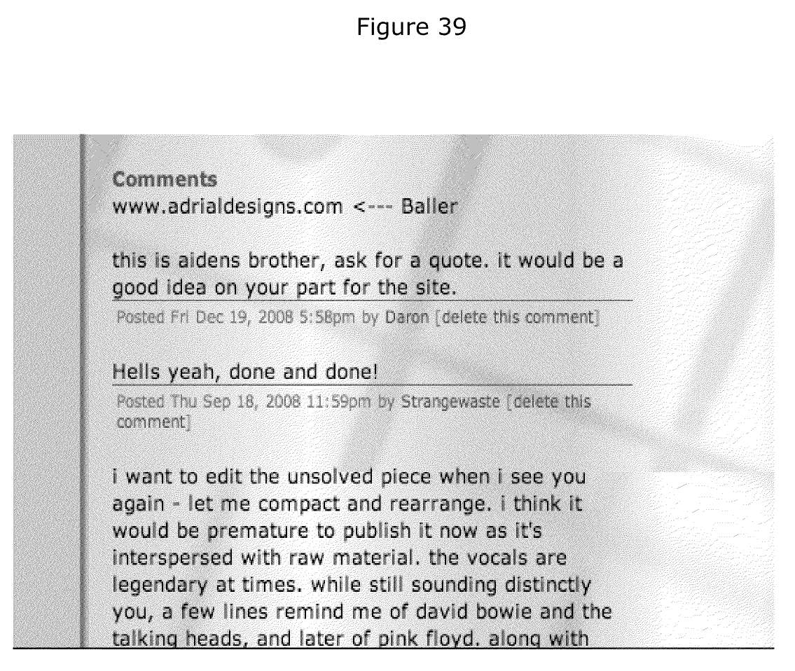

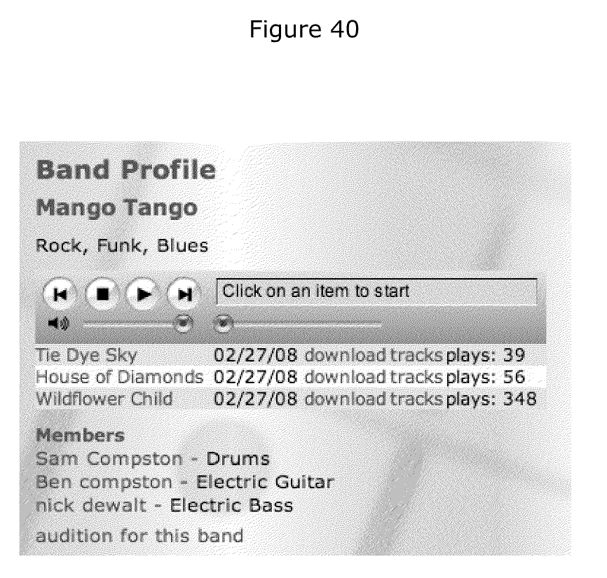

FIGS. 31-40 illustrate screen shots of GUIs showing aspects of the interactive website for systems and methods of the present invention, with substantive illustration of virtual band and musician aspects in particular.

By way of example and not limitation, the following provides an illustration of user interaction according to one embodiment of the present invention, specifically by a user guide or help-based instructions. This description supports methods for musicians to connect to other musicians remotely by using web-based interaction, i.e., using the Internet to log onto a website online and exchange music (through upload/download) and ideas. Also, listeners can also log onto the website to discover new bands and musicians they might like as they can search for bands and musicians by genre. Several bands and musicians are featured on the home page, and the most played songs are listed in on the home page. Registration To participate in MyBlogBand.com, a user must register. To register, a user must enter a username, email and password. If the username or email are already in use, the user must pick another. Once registered, the user is logged in and can post comments to a band page. They also may continue on to become musicians. Any registered user can post comments on the band profile page. Musicians can fill out a profile, post pictures and tracks for others to listen to. Any of this can be edited at any time by logging in. Musicians may also participate in bands by starting a band and inviting other musicians to join, or auditioning for one of the many bands already on the site. To log in, enter your username and password in the log in boxes at the left hand column. If you've forgotten your password, you may click on “email me my password” and your password will be mailed to your email address. Once logged in, the log in box goes away, and a menu with various options appears in the left hand column. If you did not create a musician profile when you registered, you can create one now. If you have already created a musicians profile, you can view your profile by clicking on “view profile”. You can make changes to or delete your profile by clicking on “edit my profile”. It is important to choose genres that represent your music, as that will help others with similar interests find you. It is also important to choose instruments that you play, the amount of time you have been playing that instrument, and the state you live in as this information will be used by other musicians on the site to find you. You can change your password by clicking on the “change my password” link in the left hand column. You can add and remove images from your image gallery by clicking on “manage my images”. Images are uploaded by selecting a local file using the “Browse” button and then clicking “Upload”. Only jpeg images should be uploaded. Images can be reordered by using the pulldown boxes next to each image and selecting which position you would like that image to occupy. The first image is used as the thumbnail image for your musicians profile page, so choose an image that you like. You can add and remove tracks from your profile by clicking on the “manage my tracks” link. Tracks can be uploaded by selecting the file using the “Browse” button and then clicking on the “Upload” button. Depending on the type of connection you have, it may take several minutes to upload a track. Do not click on anything else while a track is uploading. Only MP3 tracks will be playable by the online player. Tracks must be named before they are uploaded. Bands Musicians can participate in bands in several ways. A musician may start a band. A band has a profile very similar to the musician profile. It is important to choose genres that are representative of this band so other musicians and listeners can find the band. Bands also have image galleries that work identically to the Musician image gallery described above. Once a musician creates a band, they can invite other musicians to join the band by searching for them using the “Musicians” menu item at the top of the page. If you have at least one band, and the musician is not in that band, a link will show up on that musicians profile page called “invite this musician to join your band”. This will open a page where you select the band that you want to invite them to join and an optional message. An email will be sent to the invited musician. They can log in and accept your invitation. Band members should create at least one song that is representative of the band. This is done by clicking on the band name in the left hand column and then clicking on “manage band music”. This will open a page where any current songs are listed, and a link to add a new song is available. Add a new song by clicking on the “add a new song” link and filling in a title and optional description. Once the song is created, tracks can be uploaded for this song. A song may have many tracks as the song develops and new parts are added. Tracks are added by clicking on the “tracks” link under the song on the “manage band music” page. Select a local file using the “Browse” button and then click “Upload”. Please wait for the upload to complete as it may take some time depending on the type of internet connection you have. The first track uploaded becomes the “public” track for this song and is the one that shows up on the band profile page for this song. You can add notes for this track so that others know what the track is. You can make this a “private” track so that only other band members can see it, and you can decide if you want to make it downloadable by others. As more tracks are uploaded, you can decide which one is the “public” track. For instance, if you add a guitar solo to the song, you can upload a mix that includes this solo and make that the “public” track. Any musician can audition for any band that they are not already in. To do this, find a band using the “Bands” menu item at the top of the page, and click on the “audition for this band” link. This will allow you to upload a track for a song. The band members will get an email. A band member can log in, find the band and song that the musician has auditioned for, and listen to the track. The band members can keep the track or delete it. If they like the musician, they can invite them to join the band by clicking on their name and clicking on “invite this musician to join your band” on the profile page as described above.

Certain modifications and improvements will occur to those skilled in the art upon a reading of the foregoing description. By way of example and not limitation, methods for providing a filing system for albums or collections of tracks that provides for multiple musician and/or multiple group collaborations as set forth hereinabove. Also, a business model including the methods hereinabove wherein advertising is sold for generating targeted traffic for music, including the use of musical keywords wherein each music genre has keywords specifically associated with it so that advertisements can address niche markets related to those genres. The above mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. A system for providing online music composition comprising: an interactive website accessible from a remote computer device via a network, the website being operable for receiving a first track uploaded through the network from a first remote source, the first track created by at least one musician entity; the website further operable for automatically saving and categorizing the at least one track according to the musician entity and a music genre; the website further operable for receiving a second track from a second remote source, the second track created by a second musician entity, selectively combining the first track and the second track, and saving the combined tracks for creating a collaborative music composition.

2. The system of claim 1, wherein the system is accessible remotely via a multiplicity of musician entities for uploading, editing, and creating collaborative music compositions selectively with other musician entities.

3. The system of claim 1, wherein the collaborative music composition is editable via the interactive website.

4. A method for providing online music composition comprising the steps of: providing an interactive website accessible with a remote computer via a network, wherein the website is operable for receiving a first track from a first remote source, the first track being created by at least one musician entity, saving and categorizing the at least one track according to musician and genre, receiving a second track from a second remote source, the second track created by a second musician entity, selectively combining the first track and the second track, and saving the combined tracks for creating a collaborative music composition.

5. The method of claim 4, further including the step of editing the combined tracks.

6. The method of claim 4, further including the step of receiving a multiplicity of tracks from more than one remote musician entity.

7. A method for online music collaboration including the steps of: providing an interactive website accessible with at least one remote computer device via a network, wherein the website is operable for receiving a first track from a first remote source, the first track being created by at least one musician entity, saving and categorizing the at least one track according to musician and genre, receiving a second track from a second remote source, the second track created by a second musician entity, selectively combining the first track and the second track, and saving the combined tracks for creating a collaborative music composition; and wherein the musician entities are self-selectively combinable to form at least one virtual band for online music creation, editing, and social network-based distribution through the interactive website.

8. The method of claim 7, further including the step of editing the combined tracks.

9. The method of claim 7, further including the step of receiving a multiplicity of tracks from more than one remote musician entity

10. The method of claim 7, further including the step of automatically categorizing the virtual bands based upon a track categorization of composite tracks and/or based upon a musician categorization of any or all of the at least one musician entities that contribute at least one track to the composite track.
